(19) United States
(12) Patent Application Publication
(10) Pub. No.: US 2013/0171975 A1
(43) Pub. Date: Jul. 4, 2013

(54) Selectively Buffering Media In Response To A Session Disruption Within A Wireless Communications System

(71) Applicants: Mark Aaron Lindner, Superior, CO (US); Shane Richard Dewing, San Diego, CA (US); Anthony Pierre Stonefield, San Diego, CA (US)

(72) Inventors: Mark Aaron Lindner, Superior, CO (US); Shane Richard Dewing, San Diego, CA (US); Anthony Pierre Stonefield, San Diego, CA (US)

(73) Assignee: QUALCOMM INCORPORATED, San Diego, CA (US)

(21) Appl. No.: 13/343,225

(22) Filed: Jan. 4, 2012

(51) Int. Cl. H04W 4/12

(52) U.S. Cl. 455/412.1

(57) ABSTRACT

In an embodiment, a communication entity receives, during a communication session, media to be transmitted in association with the communication session at least between first and second user equipments (UEs). The communication entity detects a session disruption (e.g., a signal fade condition, backhaul congestion, etc.) during the communication session. In response to the detection of the session disruption, the communication entity records the received media. Upon detecting that the session disruption is no longer present, the communication entity transmits the recorded media. In an example, the communication entity can correspond to one of the UEs in the communication session such that the received media is received from a user of the respective UE, or alternatively to an application server that is arbitrating the session for the UEs such that the received media is received from one of the UEs in the communication session.

### BACKGROUND OF THE INVENTION

1. Field of the Invention

Embodiments of the invention relate to selected buffering media in response to a session disruption within a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1×EV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the Node Bs generally interact with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, a communication entity receives, during a communication session, media to be transmitted in association with a communication session at least between first and second user equipments (UEs). The communication entity detects a session disruption (e.g., a signal fade condition, a backhaul congestion, etc.) during the communication session. In response to the detection of the session disruption, the communication entity records the received media. Upon detecting that the session disruption is no longer present, the communication entity transmits the recorded media. In an example, the communication entity can correspond to one of the UEs in the communication session such that the received media is received from a user of the respective UE, or alternatively to a server that is arbitrating the session for the UEs such that the received media is received from one of the UEs in the communication session.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2A illustrates the core network of FIG. 1 according to an embodiment of the present invention.

FIG. 2B illustrates the core network of FIG. 1 according to another embodiment of the present invention.

FIG. 2C illustrates an example of the wireless communications system of FIG. 1 in more detail.

FIG. 3A is an illustration of a user equipment (UE) in accordance with at least one embodiment of the invention.

FIG. 3B illustrates an example of a forward link signal fade condition.

FIG. 4 illustrates a high-level process of selectively recording media associated with a communication session in response to detection of a session disruption in accordance with an embodiment of the invention.

FIG. 5A illustrates an example implementations of the process of FIG. 4 in accordance with an embodiment of the invention.

FIG. 5B illustrates an example implementations of the process of FIG. 4 in accordance with another embodiment of the invention.

FIG. 5C illustrates an example implementations of the process of FIG. 4 in accordance with yet another embodiment of the invention.

FIG. 6A illustrates a process of recovering from a session disruption in accordance with an embodiment of the invention.

FIG. 6B illustrates an example implementation of FIG. 6A whereby the given communication entity corresponds to a UE from FIG. 5A or 5B in accordance with an embodiment of the invention.

FIG. 6C illustrates another example implementation of FIG. 6A whereby the given communication entity corresponds to a UE from FIG. 5A or 5B in accordance with another embodiment of the invention.

FIG. 7 illustrates a communication device 700 that includes logic configured to perform functionality in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

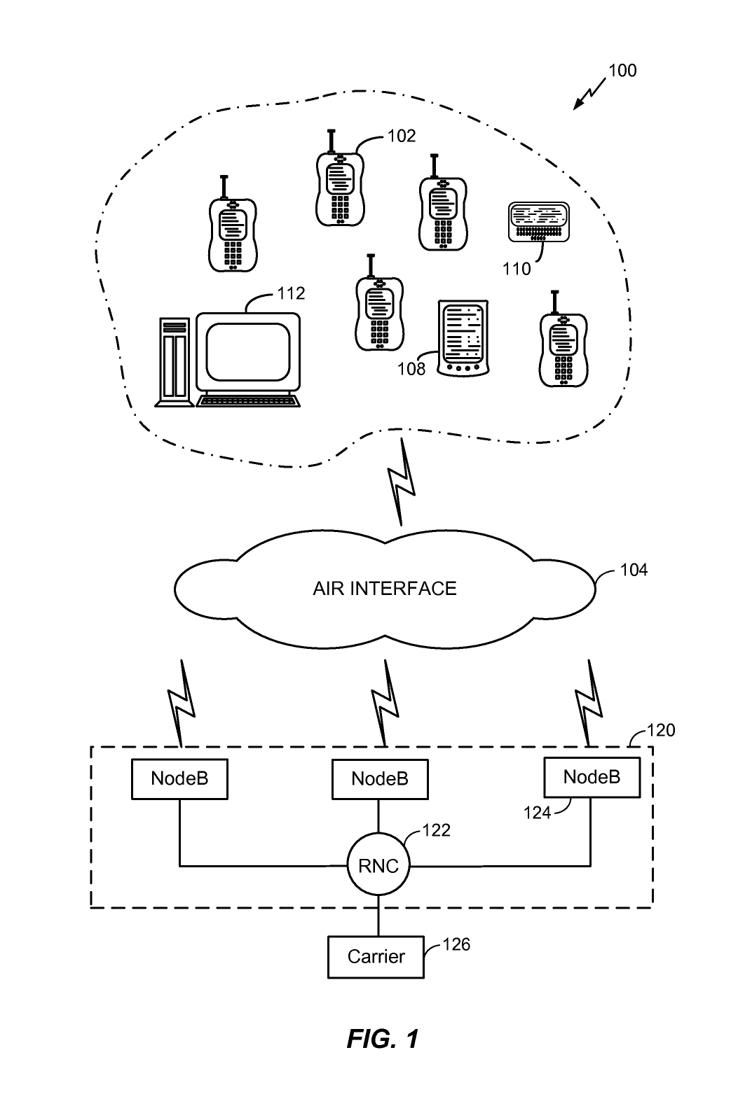

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

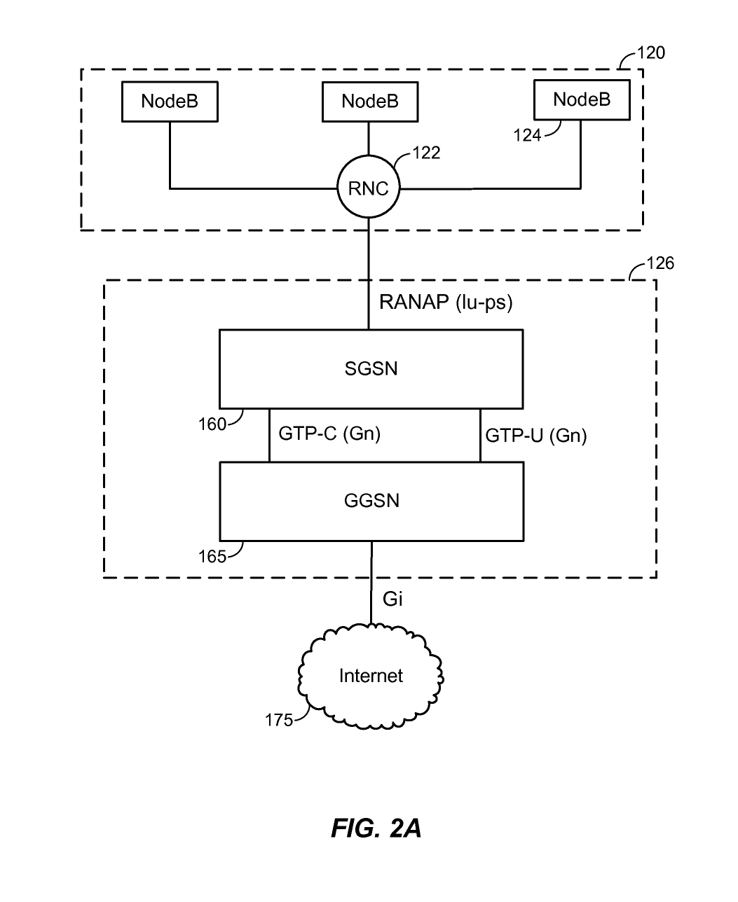

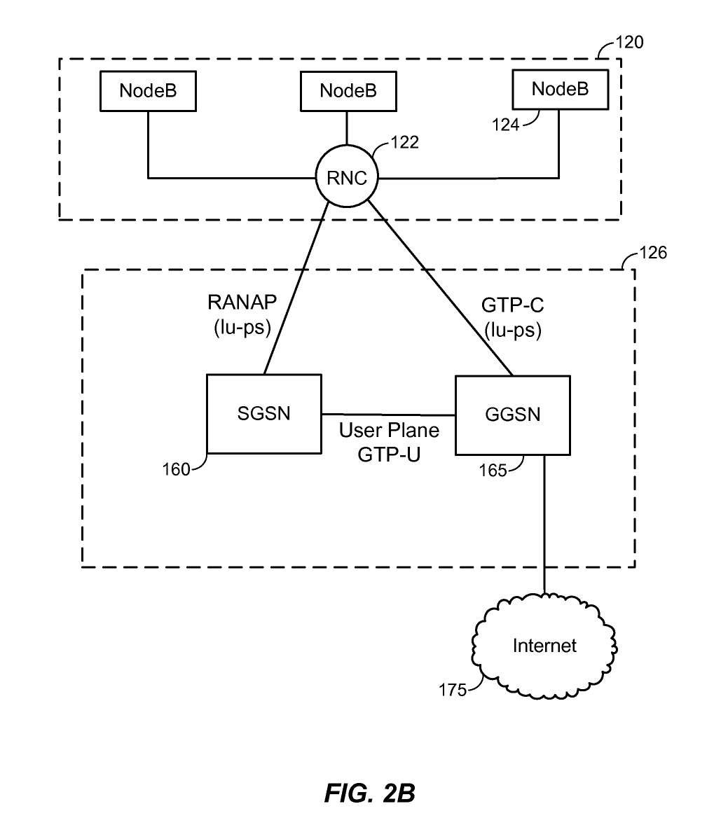

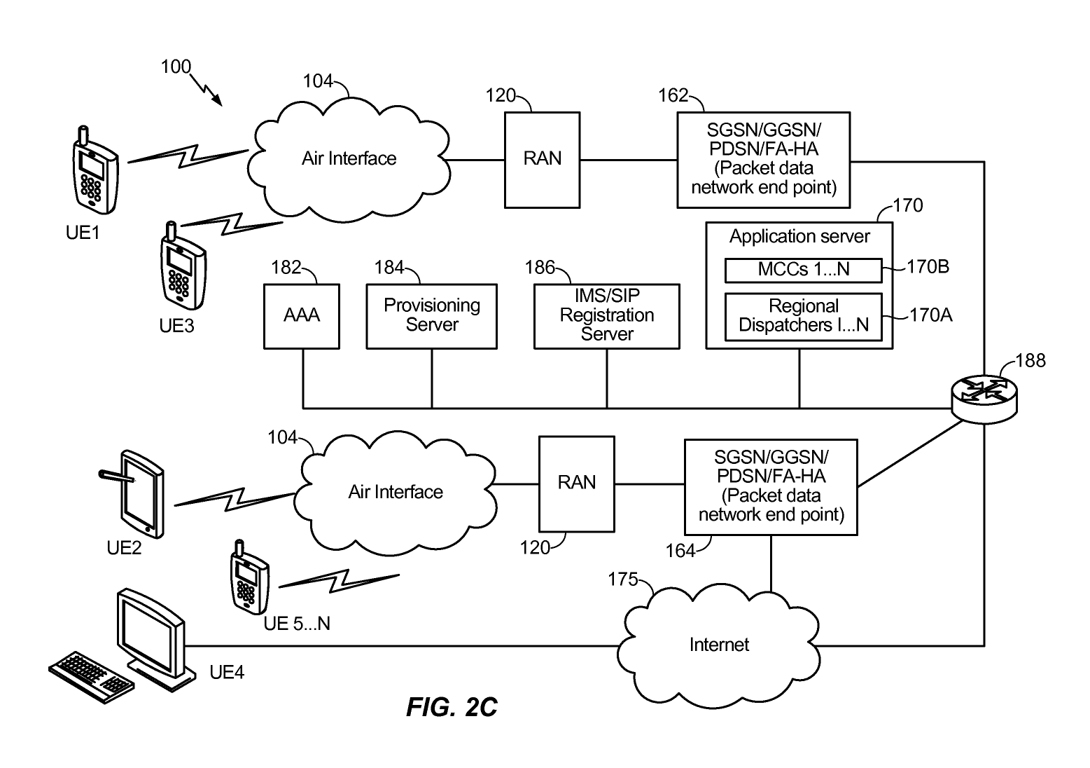

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SGSN 160 to the GGSN 165, which is handling the subscriber's session.

Three forms of GTP are used by the GPRS core network; namely, (i) GTP-U, (ii) GTP-C and (iii) GTP' (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Radio Access Network Application Part (RANAP) protocol. RANAP operates over a Iu interface (Iu-ps), with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). In the embodiment of FIG. 2, the Gn between the SGSN 160 and the GGSN 165 carries both the GTP-C and the GTP-U. While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

FIG. 2B illustrates the core network 126 according to another embodiment of the present invention. FIG. 2B is similar to FIG. 2A except that FIG. 2B illustrates an implementation of direct tunnel functionality.

Direct Tunnel is an optional function in Iu mode that allows the SGSN 160 to establish a direct user plane tunnel between RAN and GGSN within the Packet Switched (PS) domain. A direct tunnel capable SGSN, such as SGSN 160 in FIG. 2B, can be configured on a per GGSN and per RNC basis whether or not the SGSN can use a direct user plane connection. The SGSN 160 in FIG. 2B handles the control plane signaling and makes the decision when to establish Direct Tunnel. When the Radio Bearer (RAB) assigned for a PDP context is released (i.e. the PDP context is preserved) the GTP-U tunnel is established between the GGSN 165 and SGSN 160 in order to be able to handle the downlink packets.

The optional Direct Tunnel between the SGSN 160 and GGSN 165 is not typically allowed (i) in the roaming case (e.g., because the SGSN needs to know whether the GGSN is in the same or different PLMN), (ii) where the SGSN has received Customized Applications for Mobile Enhanced Logic (CAMEL) Subscription Information in the subscriber profile from a Home Location Register (HLR) and/or (iii) where the GGSN 165 does not support GTP protocol version 1. With respect to the CAMEL restriction, if Direct Tunnel is established then volume reporting from SGSN 160 is not possible as the SGSN 160 no longer has visibility of the User Plane. Thus, since a CAMEL server can invoke volume reporting at anytime during the life time of a PDP Context, the use of Direct Tunnel is prohibited for a subscriber whose profile contains CAMEL Subscription Information.

The SGSN 160 can be operating in a Packet Mobility Management (PMM)-detached state, a PMM-idle state or a PMM-connected state. In an example, the GTP-connections shown in FIG. 2B for Direct Tunnel function can be established whereby the SGSN 160 is in the PMM-connected state and receives an Iu connection establishment request from the UE. The SGSN 160 ensures that the new Iu connection and the existing Iu connection are for the same UE, and if so, the SGSN 160 processes the new request and releases the existing Iu connection and all RABs associated with it. To ensure that the new Iu connection and the existing one are for the same UE, the SGSN 160 may perform security functions. If Direct Tunnel was established for the UE, the SGSN 160 sends an Update PDP Context Request(s) to the associated GGSN(s) 165 to establish the GTP tunnels between the SGSN 160 and GGSN(s) 165 in case the Iu connection establishment request is for signaling only. The SGSN 160 may immediately establish a new direct tunnel and send Update PDP Context Request(s) to the associated GGSN(s) 165 and include the RNC's Address for User Plane, a downlink Tunnel Endpoint Identifier (TEID) for data in case the Iu connection establishment request is for data transfer.

The UE also performs a Routing Area Update (RAU) procedure immediately upon entering PMM-IDLE state when the UE has received a RRC Connection Release message with cause “Directed Signaling connection re-establishment” even if the Routing Area has not changed since the last update. In an example, the RNC will send the RRC Connection Release message with cause “Directed Signaling Connection re-establishment” when it the RNC is unable to contact the Serving RNC to validate the UE due to lack of Iur connection (e.g., see TS 25.331 [52]). The UE performs a subsequent service request procedure after successful completion of the RAU procedure to re-establish the radio access bearer when the UE has pending user data to send.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2C illustrates an example of the wireless communications system 100 of FIG. 1 in more detail. In particular, referring to FIG. 2C, UEs 1 . . . N are shown as connecting to the RAN 120 at locations serviced by different packet data network end-points. The illustration of FIG. 2C is specific to W-CDMA systems and terminology, although it will be appreciated how FIG. 2C could be modified to confirm with a 1×EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2C, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2C are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2C, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

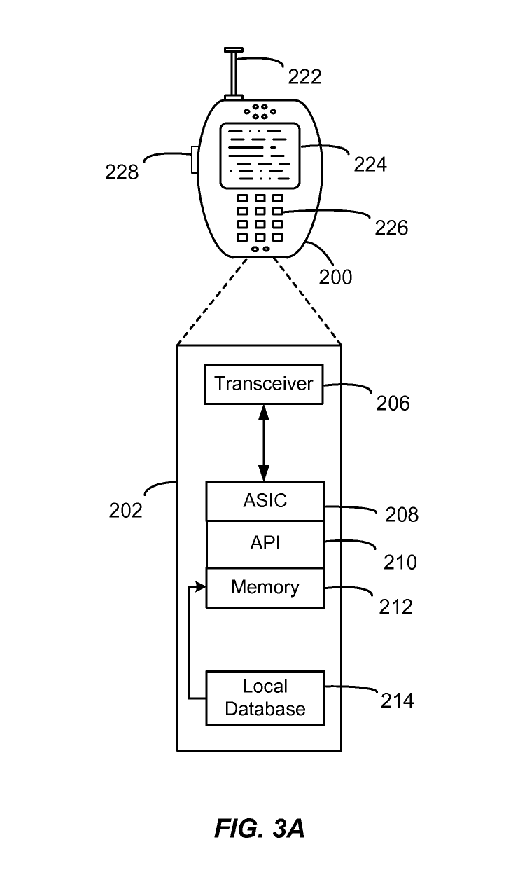

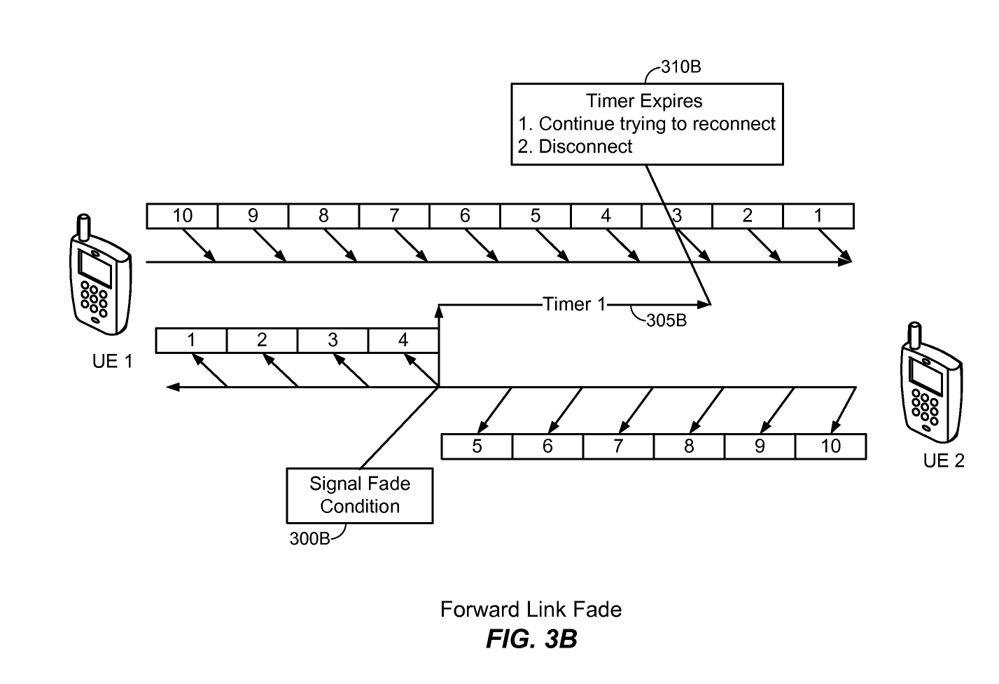

Referring to FIG. 3A, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3A are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

Voice over IP (VoIP) has been implemented in various ways using both proprietary and open protocols and standards. Examples of technologies used to implement VoIP include, but are not limited to: H.323, IP Multimedia Subsystem (IMS), Media Gateway Control Protocol (MGCP), Session Initiation Protocol (SIP), Real-time Transport Protocol (RTP), and Session Description Protocol (SDP).

One of the design considerations of RTP was to support a range of multimedia formats (such as H.264, MPEG-4, MJPEG, MPEG, etc.) and allow new formats to be added without revising the RTP standard. An example of a header portion of a 40-octet overhead RTP packet may be configured as follows:

TABLE 1
Example of a RTP packet header

| | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 | 30 | 31 |

| | | | |
|---|---|---|---|
| Octet 1, 5, 9 . . . | Octet 2, 6, 10 . . . | Octet 3, 7, 11 . . . | Octet 4, 8, 12 . . . |

| | | | | |
|---|---|---|---|---|
| 1-4 | Version | IHL | Type of service | Total length |

| | | | |
|---|---|---|---|
| 5-8 | Identification | Flags | Fragment offset |

| 9-12 | Time to live | | | | Protocol | | Header checksum |
|---|---|---|---|---|---|---|---|
| 13-16 | Source address | | | | | | |
| 17-20 | Destination address | | | | | | |
| 21-24 | Source port | | | | | | Destination port |
| 25-28 | Length | | | | | | Checksum |
| 29-32 | V = 2 | P | X | CC | M | PT | Sequence number |

| | |
|---|---|
| 33-36 | Timestamp |
| 37-40 | Synchronization source (SSRC) number |

Referring to Table 1, the fields of the RTP packet header portion are well-known in the art. After the RTP header portion, the RTP packet includes a data payload portion. The data payload portion can include digitized samples of voice and/or video. The length of the data payload can vary for different RTP packets. For example, in voice RTP packets, the length of the voice sample carried by the data payload may correspond to 20 milliseconds (ms) of sound. Generally, for longer media durations (e.g., higher-rate frames), the data payload either has to be longer as well, or else the quality of the media sample is reduced.

Generally, RTP sender captures multimedia data (e.g., from a user of the RTP sender), which is then encoded, framed and transmitted as RTP packets with appropriate timestamps and increasing sequence numbers. The RTP packets transmitted by the RTP sender can be conveyed to a target RTP device (or RTP receiver) via a server arbitrating a session between the RTP sender and receiver, or alternatively directly from the RTP sender to the RTP receiver via peer-to-peer (P2P) protocols. The RTP receiver receives the RTP packets, detects missing packets and may perform reordering of packets. The frames are decoded depending on the payload format and presented to the user of the RTP receiver.

As will be appreciated by one of ordinary skill in the art, during the course of a communication session, it is possible that one or more session participants will experience a session disruption. As used herein, a session disruption corresponds to an outage whereby communication performance for a given UE drops below a threshold level (or is severed completely) for an indefinite period of time.

In an example, a session disruption can be caused by a signal fade condition. Signal fade conditions can result from attenuation in wireless signals being used to support the communication session, and may vary with time, geographical position and/or radio frequency. In wireless systems, signal fading can be caused by multipath propagation, referred to as multipath induced fading, or due to shadowing from obstacles affecting the wave propagation, sometimes referred to as shadow fading. For example, the signal fade condition caused with respect to a particular session participant can occur when the session participant drives into a tunnel, moves out of a coverage area of a serving base station, when a new interfering signals degrades a connection between the session participant and a serving base station, and so on. For example, signal fade conditions can be detected by UEs via a modem at an air-interface layer, which then notifies an operating system (OS) network interface on the UE that in turn notifies an application executing on the UE, or alternatively based on a detection of an extended absence of incoming RTP frames on a forward link channel through the use of a traffic inactivity timer. Signal fade conditions can also be inferred by the application server 170 when the application server 170 transmits a threshold number of RTP packets to a target UE without receiving ACKs within a threshold period of time.

As will be appreciated, signal fade conditions are merely one potential cause of a session disruption. Other examples can be caused by factors external to the physical layer or air-interface, such as backhaul congestion (e.g., a congested PDSN, firewall blocking port, hitting bandwidth limit, etc). Also, session disruption at a particular UE can be caused at any point between the particular UE and the other UE(s) participating in the communication session. Thus, a signal fade condition at one UE causes a session disruption at the other participating UE(s) because the end-to-end communication link between the respective session participants has been broken.

FIG. 3B illustrates an example of one particular type of session disruption (i.e., a forward link signal fade condition) from the perspective of UE 1. Accordingly, between t1 through t4 at UE 1, there is no signal fade condition. Next, a signal fade condition occurs at t4, 300B, such that packets at t5 through t10 fail to arrive successfully at UE 1. UE 1 eventually detects the signal fade after expiration of a wait timer, 305B, after which UE 1 can either continue trying to reconnect or simply disconnect from the call, 310B.

Accordingly, session disruptions typically result in dropped calls, with the session participants having the option of re-establishing their previous communication session at some later point in time after the session disruption is no longer present. For example, if UE 1 is engaged with UE 2 in a call and UE 2 enters a tunnel, the call is dropped. Later, UE 1 or UE 2 may attempt to re-establish their call with each other when UE 2 exits the tunnel and re-establishes its connection with a serving access network or RAN 120.

As will be appreciated, session disruptions can cause calls to end prematurely in a somewhat jarring manner. A session participant may be halfway through an important sentence, for instance, when the call is dropped due to a session disruption (e.g., caused by a signal fade condition, backhaul congestion, etc.). Accordingly, embodiments of the invention are directed to selectively recording media associated with a communication session after a session disruption is detected for later transmission to a target UE.

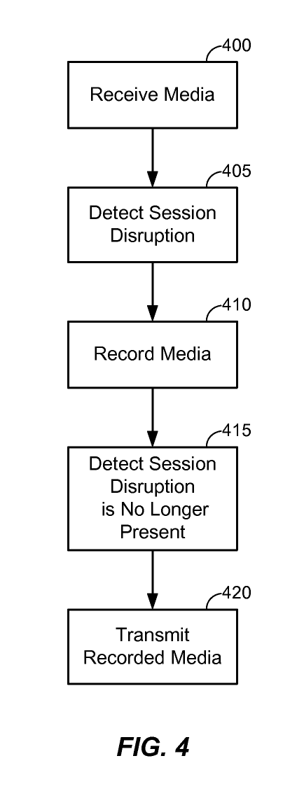

FIG. 4 illustrates a high-level process of selectively recording media associated with a communication session in response to detection of a session disruption in accordance with an embodiment of the invention. As will become clear from the description below, the process of FIG. 4 can be implemented by a transmitting UE undergoing a session disruption during a communication session (e.g., a server-arbitrated communication session or peer-to-peer (P2P) communication session, a one-to-one communication session between two UEs or a group communication session between three or more UEs, etc.) with at least one target UE, or alternatively by the application server 170 that is arbitrating a communication session between a set of UEs with at least one UE undergoing a session disruption.

Referring to FIG. 4, a given communication entity (e.g., a session participant or UE, the application server 170, etc.) receives media (e.g., audio data) associated with a communication session between a first UE and a second UE during a communication session, 400. For example, the media reception of 400 can correspond to a user of the first UE speaking into an audio input device of the first UE, or alternatively the media reception of 400 can correspond to the application server 170 receiving media (e.g., audio media contained in RTP frames) from the first UE for transmission to the second UE.

At some later point during the communication session, the given communication entity detects a session disruption associated with the communication session, 405. For example, the detection of 405 can correspond to the first UE detecting that the first UE is undergoing a signal fade condition based on a lack of incoming downlink RTP frames associated with the communication session, a lack of ACKs to the first UE's transmissions, and so on. Alternatively, the detection of 405 can correspond to the application server 170 detecting that a target UE of the communication session is undergoing a signal fade condition and thereby cannot receive media transmitted thereto. Alternatively, the detection of 405 can correspond to a detection (by the first UE or the application server 170) that backhaul performance between the first UE and the application server 170 and/or between the second UE and the application server 170 has dropped below a threshold level. Alternatively, the detection of 405 can correspond to a detection by the sending UE or the receiving UE that the effective data rate transfer rate on the uplink or downlink connection has fallen below a threshold level.

In response to the detection of the session disruption at 405, the given communication entity records media associated with the communication session in 410. For example, the recording that occurs at 410 can correspond to the first UE recording the audio data input by the user of the first UE even when the first UE is not capable of successfully completing transmissions of the audio data due to the session disruption. In another example, the recording that occurs at 410 can correspond to the application server 170 buffering or storing the media from the first UE for transmission to the second UE. In either case, the media is stored at 410 because the session disruption is currently blocking the ability of the given communication entity to successfully transmit the received media.

In a further example, the recording at 410 can record media that is received during the session disruption and further at least a portion of media that is received before and/or after the session disruption. For example, by virtue of recording more than merely the missed frames, a UE that misses a set of media frames from another UE may receive a set of “surrounding” media frames so that the missed set of media frames have better context. Accordingly, the recording at 410 may leverage local buffering of media such that media that was received prior to the detection of the session disruption at 405 remains available and can be added to the recorded media at 410. Likewise, the recording at 410 may continue for a period of time even after the session disruption is no longer present.

Referring to FIG. 4, at some later point in time, the given communication entity determines that the session disruption is no longer present, 415. For example, the application server 170 may receive some form of feedback from the second UE indicating that the second UE can again receive data transmissions, or the first UE may re-establish an adequate connection to its serving access network. Responsive to the detection of 415, the given communication entity transmits the recorded media in 420. In an example, the transmission of 420 can occur as soon as the given communication entity determines that the session disruption is no longer present, or alternatively can occur at some later point in time. Further, the format of the transmission that occurs at 420 can be the same as if the session disruption had not occurred. For example, if the media recorded at 410 is audio media, then audio media may be transmitted at 420 such that the session disruption results in a mere time-shifting of the media. Alternatively, the transmission that occurs at 420 may involve media reformatting. For example, if the media recorded at 410 is audio media, then the audio media may be converted into a text transcript and the text transcript may be transmitted at 420 (e.g., to reduce bandwidth, to permit the second UE to scroll through the text while also re-establishing a real-time audio session with the first UE, etc.). In a further example, the transmission of 420 can either be a direct transmission to a target UE associated with the recorded media, or alternatively can correspond to a transmission of the recorded media to an archive that can later be accessed by the target UE (or other UEs).

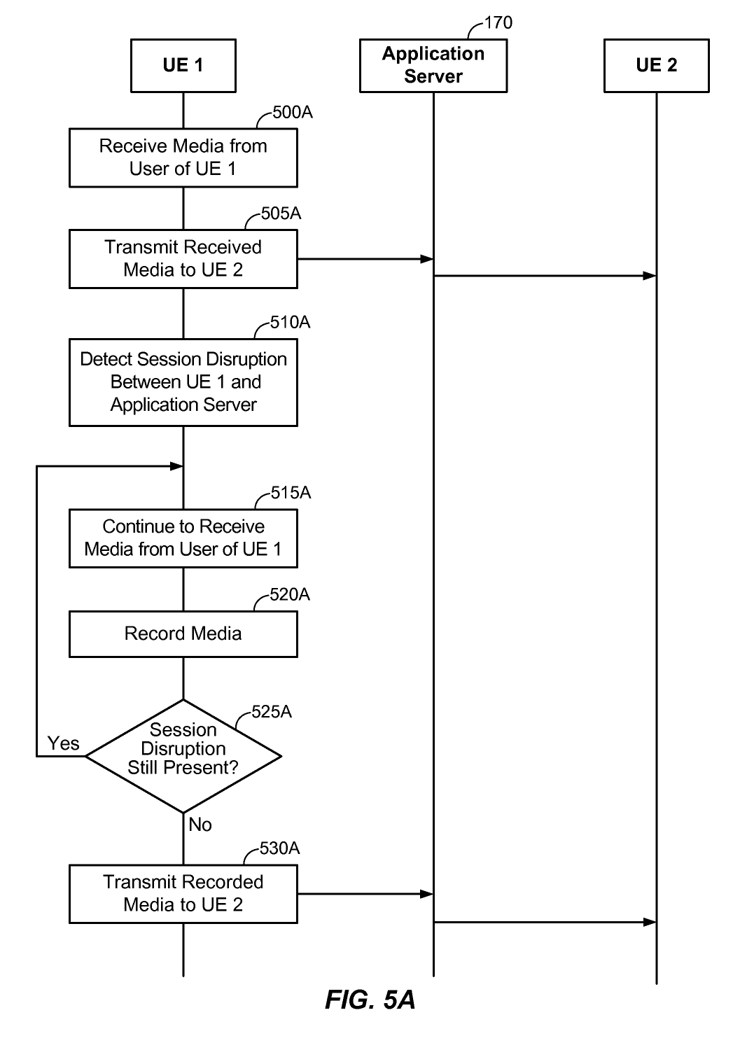

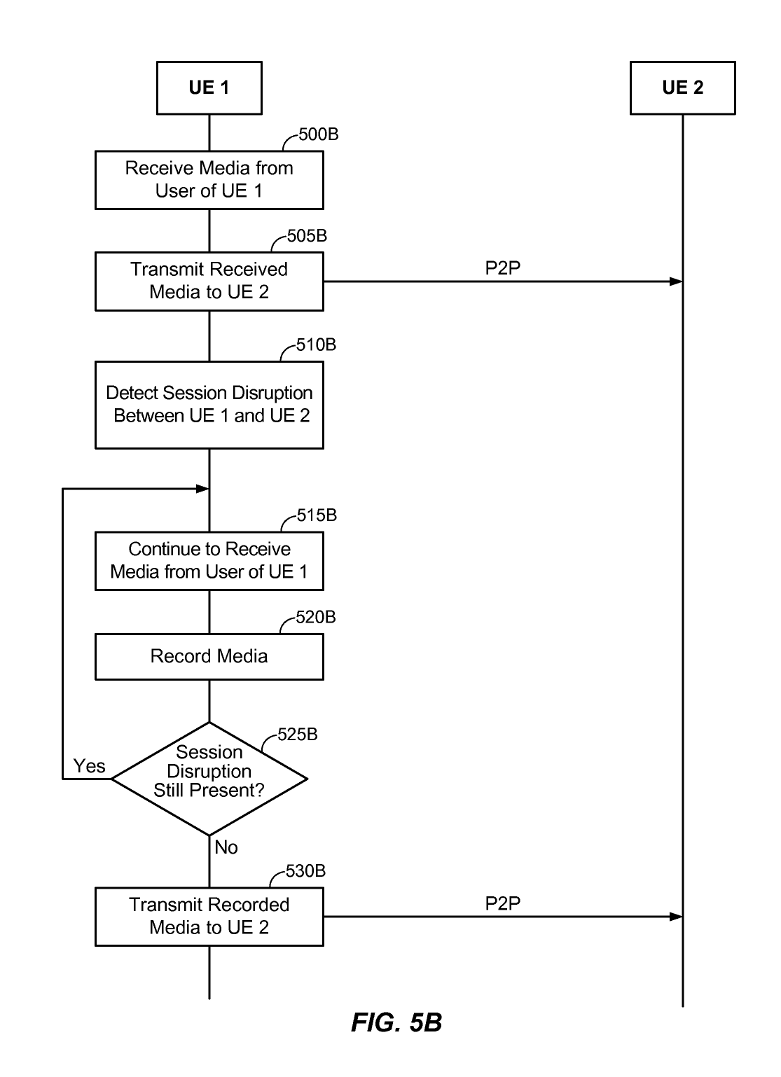

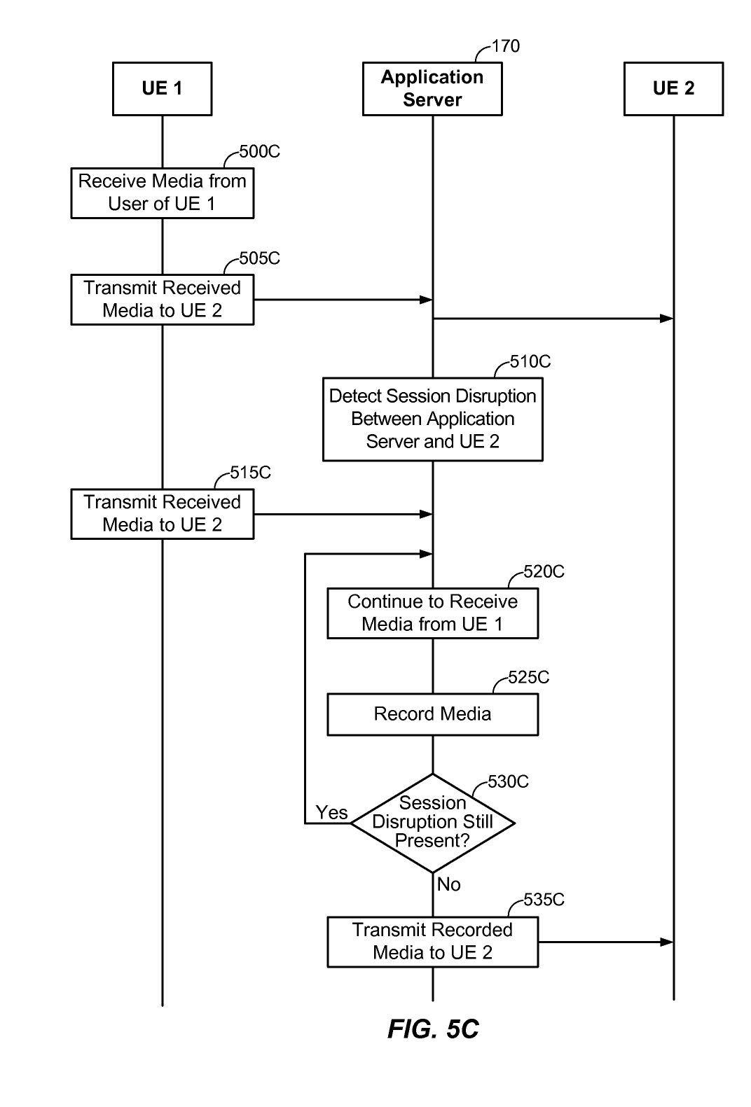

FIGS. 5A through 5C each illustrate example implementations of the process of FIG. 4. Referring to FIG. 5A, UE 1 is engaged in a communication session with UE 2 that is being arbitrated by the application server 170, and UE 1 receives media (e.g., audio data) from a user of UE 1, 500A (e.g., as in 400 of FIG. 4). UE 1 transmits the received media to the application server 170, which receives UE 1's media and re-transmits UE 1's media to target UE 2, 505A. In an example, UE 1 can encode the received media from its user into an RTP packet that is transmitted to the application server 170 in 505A. Next, 500A and 505A repeat a plurality of times during the communication session. While not shown explicitly in FIG. 5A, UE 2 can also transmit media to UE 1 through the application server 170.

At some later point in time during the communication session, UE 1 detects a session disruption between UE 1 and the application server 170, 510A (e.g., as in 405 of FIG. 4). For example, in 510A, UE 1 may detect that no packets from the application server 170 have been received at UE 1 for a threshold period of time (e.g., based on expiration of a traffic inactivity timer, etc.).

After detecting the session disruption in 510A, UE 1 continues to receive media from UE 1 in association with the communication session, 515A. For example, the user of UE 1 can be notified of the session disruption and then given an option of whether to continue his/her media input, or else simply drop out of the communication session, with the media reception at 515A implying that the user of UE 1 accepted the option to continue his/her media input.

In 520A, instead of transmitting the received media from the user to the application server 170, UE records the received media from its user (e.g., as in 410 of FIG. 4). While recording the media in 520A, UE 1 monitors traffic conditions to determine whether the session disruption is still present, 525A. If UE 1 determines that the session disruption is still present, the process returns to 515A and UE 1 continues to receive and record media from its user without transmitting the media to the target UE 2. Otherwise, if UE 1 determines that the session disruption is no longer present, UE 1 transmits the recorded media to the target UE 2 via the application server 170, 530A (e.g., as in 420 of FIG. 4). In an example, the format of the transmission that occurs at 530A can be the same as if the session disruption had not occurred. For example, if the media recorded at 520A is audio media, then audio media may be transmitted at 530A such that the session disruption results in a mere time-shifting of the media. Alternatively, the transmission that occurs at 530A may involve media reformatting. For example, if the media recorded at 520A is audio media, then the audio media may be converted into a text transcript and the text transcript may be transmitted at 530A (e.g., to reduce bandwidth, to permit the UE 2 to scroll through the text while also re-establishing a real-time audio session with UE 1, over SMS or Email, etc.).

FIG. 5B is similar to FIG. 5A, except that FIG. 5B relates to a peer-to-peer (P2P) communication session instead of a communication session that is arbitrated by the application server 170. Accordingly, the transmissions of 505B and 530B occurs via P2P protocols, with the remainder of FIG. 5B being similar to FIG. 5A (e.g., each block from FIG. B with a “B” corresponds to a similarly numbered block from FIG. 5A with an “A” except as noted above). Accordingly, a further description of FIG. 5B has been omitted for the sake of brevity.

While FIGS. 5A and 5B are related to UE 1 detecting its own session disruption, thereby resulting in recording and subsequent transmission of the recorded media, FIG. 5C is directed to a server-implemented session disruption recovery scheme.

Referring to FIG. 5C, UE 1 is engaged in a communication session with UE 2 that is being arbitrated by the application server 170, and UE 1 receives media (e.g., audio data) from a user of UE 1, 500C (e.g., as in 400 of FIG. 4). UE 1 transmits the received media to the application server 170, which receives UE 1's media and re-transmits UE 1's media to target UE 2, 505C. In an example, UE 1 can encode the received media from its user into an RTP packet that is transmitted to the application server 170 in 505C. Next, 500C and 505C repeat a plurality of times during the communication session. While not shown explicitly in FIG. 5C, UE 2 can also transmit media to UE 1 through the application server 170.

At some later point in time during the communication session, the application server 170 detects a session disruption between the application server 170 and UE 2, 510C (e.g., as in 405 of FIG. 4). For example, in 510C, the application server 170 may detect that no ACKs have been received from UE 2 for a threshold period of time (e.g., based on expiration of a traffic inactivity timer, etc.), the application may detect backhaul congestion between the application server 170 and UE 2, etc.

After detecting the session disruption in 510C, UE 1 continues to transmit media to the application server 170 directed to UE 2, 515C, and the application server 170 continues to receive the media from UE 1, 520C. For example, the user of UE 1 can be notified of the session disruption (e.g., based on a notification from the application server 170) and then given an option of whether to continue his/her media input or else simply drop out of the communication session, with the media transmission at 515C inferring that the user of UE 1 accepts the option to continue his/her media input. In this case, the user of UE 1 recognizes that UE 2 is not currently tuned to the communication session, but understands that the application server 170 will attempt to forward the media to UE 2 at a later point in time (either directly or through archive access, and either during the communication session upon reestablishment or after the communication session terminates).

In 525C, instead of transmitting the received media from UE 1 to the target UE 2, the application server 170 records the received media from UE 1 (e.g., as in 410 of FIG. 4). While recording the media in 525C, the application server 170 monitors traffic conditions to determine whether the session disruption (or disconnection) between the application server 170 and the target UE 2 is still present, 530C. If the application server 170 determines that the session disruption is still present, the process returns to 520C and the application server 170 continues to receive and record media from UE 1 without transmitting the media to the target UE 2. Otherwise, if the application server 170 determines that the session disruption is no longer present, the application server 170 transmits the recorded media to the target UE 2, 535C (e.g., as in 420 of FIG. 4). In an example, the format of the transmission that occurs at 535C can be the same as if the session disruption had not occurred. For example, if the media recorded at 525C is audio media, then audio media may be transmitted at 535C such that the session disruption results in a mere time-shifting of the media. Alternatively, the transmission that occurs at 535C may involve media reformatting. For example, if the media recorded at 525C is audio media, then the audio media may be converted into a text transcript and the text transcript may be transmitted at 535C (e.g., to reduce bandwidth, to permit the UE 2 to scroll through the text while also re-establishing a real-time audio session with UE 1, etc.).

In the above-described embodiments, FIGS. 4 through 5C are described at a relatively high-level whereby media is recorded responsive to detection of a session disruption, and later transmitted at some point after a subsequent detection that the session disruption is no longer present. However, there are numerous ways that this relatively high-level operation can be implemented, as will be described in greater detail below.

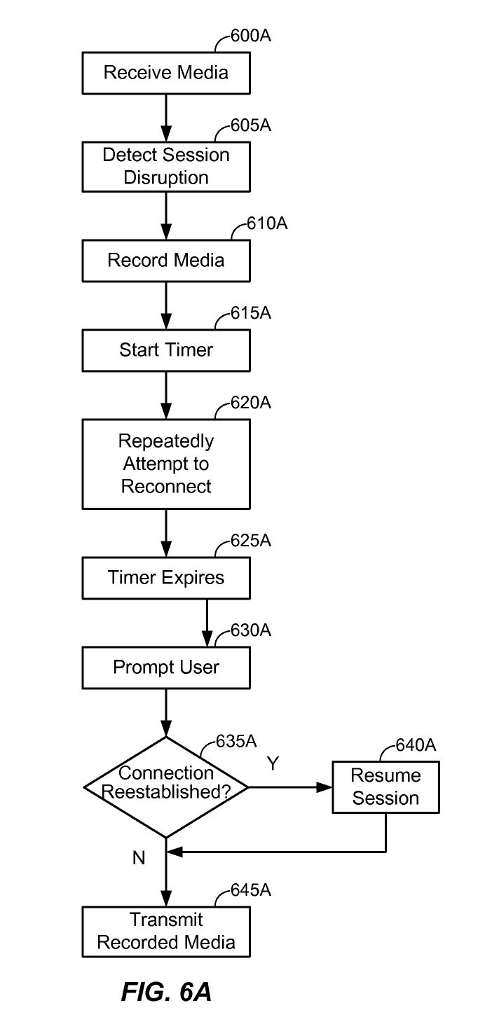

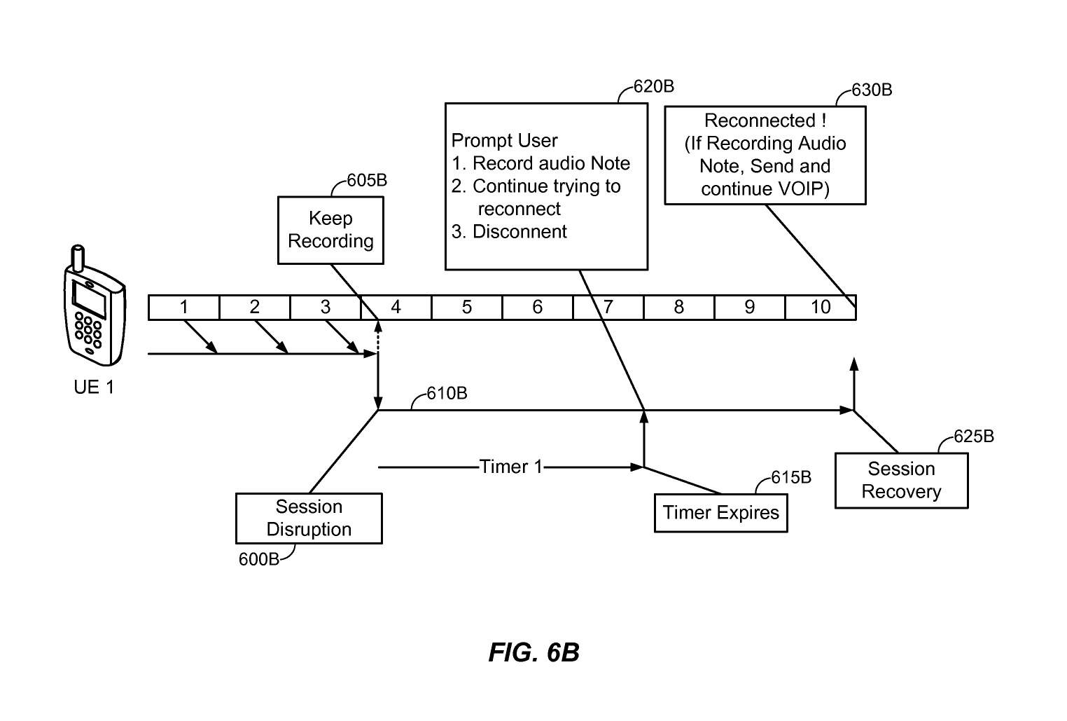

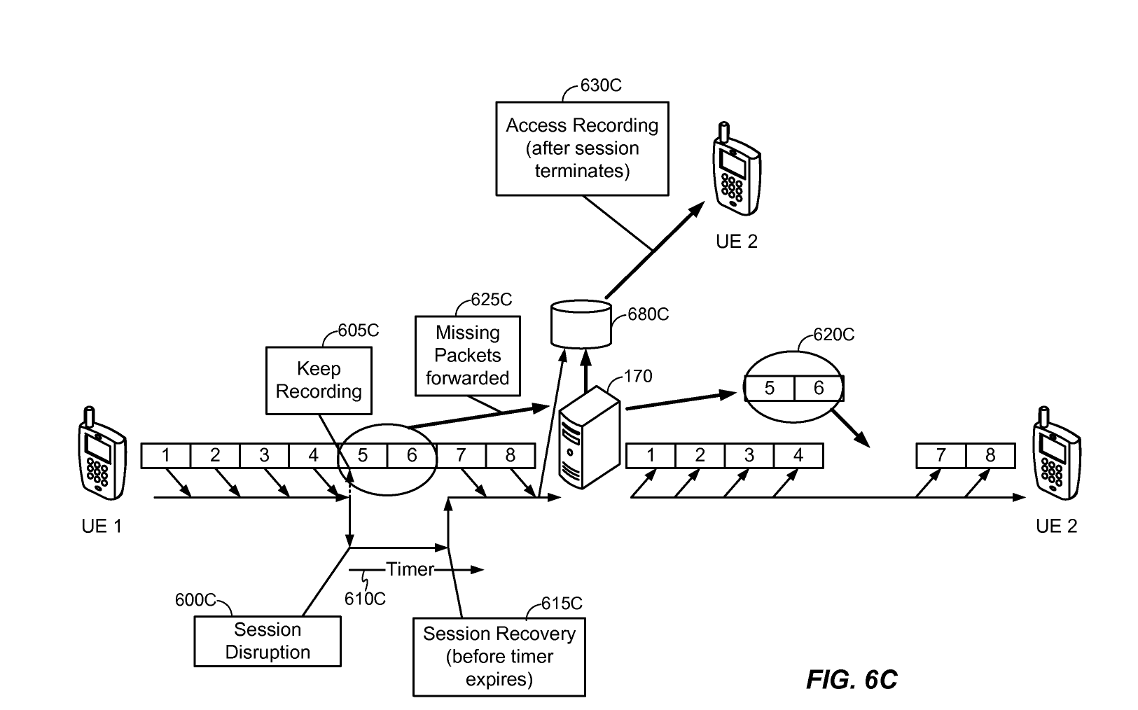

FIG. 6A illustrates a process of recovering from a session disruption in accordance with an embodiment of the invention. More specifically, in FIG. 6A, in addition to recording the media during the session disruption, UE 1 continually attempts to reconnect so as to resume the communication session.

Referring to FIG. 6A, 600A through 610A correspond to 400 through 410 of FIG. 4, respectively, and as such will not be further described for the sake of brevity. In response to the detection of the session disruption at 605A, in addition to recording the media at 610A, UE 1 also starts a wait timer in 615A. In 620A, UE 1 repeatedly attempts to reestablish the connection that was lost due to the session disruption. For example, 620A may include UE 1 repeatedly attempting to reconnect to a serving access network or RAN 120. The wait timer expires in 625A while the session disruption is still present, which triggers UE 1 to prompt the user of UE 1 to indicate whether he/she wishes to continue to input media for later distribution to UE 2 even though UE 2 will not be receiving this media in real-time due to the session disruption, 630A. For convenience of explanation, it is assumed that the user of UE 1 responds to the prompt at 630A by indicating that he/she wants to have their media recorded during the session disruption period.

Next, UE 1 determines whether the connection has successfully been reestablished such that the session disruption is no longer present, 635A. If UE 1 determines that the connection has been successfully reestablished within a threshold period of time, UE 1 resumes the communication session in 640A and also transmits the recorded media from the session disruption period in 645A. The combination of 640A and 645A can result in two simultaneous audio streams being transmitted from UE 1, in an example. Alternatively, in the case of an audio session, the session may resume via real-time audio transmissions in 640A while the transmission of 645A may correspond to a text transcript of the recorded audio media so that a target UE can listen to and participate in the real-time session at the same time that the target UE displays textual portions of the recorded media from the session disruption period. Returning to 635A, if UE 1 determines that the connection has not been successfully reestablished within the threshold period of time, UE 1 transmits the recorded media at 645A at some later point in time (after the session disruption is over) without resuming the communication session.

FIG. 6B illustrates an example implementation of FIG. 6A whereby the given communication entity corresponds to UE 1 from FIG. 5A or 5B in accordance with an embodiment of the invention. Accordingly, t1 through t3 correspond to 500A through 505A or 500B through 505B of FIG. 5B, such that there is no session disruption. Next, a session disruption is detected at t4, 600B, and UE 1 records media during the session disruption period, 605B. UE 1 also starts the wait timer in t4, 610B. After the wait timer expires at t7, 615B, the user is prompted as to whether to record media during the session disruption period (e.g., an “audio note”), UE 1 continues attempting to reconnect to the RAN 120 and UE 1 will disconnect if unable to reconnect within a threshold period of time, 620B. At t10, the session disruption terminates (“session disruption recovery”), 625B, and UE 1 is reconnected to the RAN 120, 630B, after which the transmissions of 640A and/or 645A of FIG. 6A may occur.

FIG. 6C illustrates an example implementation of FIG. 6A whereby the given communication entity corresponds to UE 1 from FIG. 5A or 5B in accordance with another embodiment of the invention. Accordingly, t1 through t4 correspond to 500A through 505A or 500B through 505B of FIG. 5B, such that there is no session disruption. Next, a session disruption is detected at t5, 600C, and UE 1 records media during the session disruption period, 605C. UE 1 also starts the wait timer in t5, 610C. Before the wait timer expires, at t7, the session disruption terminates (“session disruption recovery”), 615C. Accordingly, the session disruption period lasted between t5 and t6, such that RTP packets that would have been transmitted by UE 1 at t5 and t6 are recorded and not transmitted within the session.

Referring to FIG. 6C, instead of transmitting the missing packets from t5 and t6 within the existing communication session, UE 1 resumes the communication session in real-time by transmitting the next packet for t7 to the application server 170, which forwards the media to UE 2 without the packets for t5 and t6, 620C. UE 1 transmits the missing packets for t5 and t6, 625C, for archival by the application server 170 within an archive database, 680C. Accordingly, at some later point in time (e.g., either during the communication session or after the communication session ends), UE 2 may log onto the archive database 680C and retrieve the missing packets for t5 and t6, 630C. As will be appreciated, the archive database 680C can be configured to store additional media that puts the “missing” packets in context, such that if the missing packets correspond to missing audio data the archive database 680C can store 10 seconds before and after the session disruption period, in an example.

While above-described example embodiments describe different procedures by which media can be recorded in response to detection of a session disruption for later transmission to a target UE, in other embodiments, the communication session can be disrupted to different degrees and a response to a given session disruption can be based on its associated degree.

For example, assume that a communication session between UEs 1 and 2 begins with both UEs 1 and 2 having good connections to fast networks (e.g., WiFi, 3G, 4G, etc.). Next, assume that performance on UE 1's connection begins to degrade. For example, the network may experience backhaul congestion, UE 1 may enter a high-frequency zone or may move further away from its serving access point or base station, UE 1 may transition to a different and lower-performance network, etc. In this case, assume that the performance level associated with UE 1's connection drops below a first threshold which prompts a first session-reduction response. For example, the first session-reduction response can correspond to dropping video while maintaining audio for a video call, such that the context for the call is maintained and is not torn down. In another example, the first session-reduction response can be to maintain the context and wait for UE 1 to regain a better connection. In another example, the first session-reduction can convert a full-duplex communication session to a half-duplex communication session so that UE 1 need only concern itself with transmitted media or receiving media, but not both.

After UE 1's connection drops below the first threshold, UE 1's connection may subsequently rise above the first threshold. If so, the parameters associated with the communication session are restored and the first session-reduction response is reversed. Alternatively, UE 1's connection may further drop below a second threshold (e.g., where the second threshold is associated with lower-perceived performance than the first threshold, such as an excessive number of session disruptions or a more severe session disruption), which triggers a second session-reduction response. In an example, the second session-reduction response can correspond to execution of 410 of FIG. 4, whereby the context for the communication session is torn down and UE 1 simply records media for later transmission to UE 2 as discussed above with respect to FIGS. 4 through 6C. In another example, the second session-reduction response can correspond to another intermediate session reduction that maintains the context for the communication session between UEs 1 and 2 but further reduces the quality of the communication session (e.g., a full-duplex video session can be reduced to a full-duplex audio-only session after the first threshold is breached, and the full-duplex audio-only session can be reduced to a half-duplex audio session after the second threshold is breached, etc.). This procedure can continue for N thresholds with N associated session-reduction responses. In an example, the Nth session-reduction response can correspond to the embodiments described above, whereby the context for the communication session is torn down and UE 1 simply records media for later transmission to UE 2 as discussed above with respect to FIGS. 4 through 6C. Also, so long as the context for the communication session is maintained, the above-noted session-reduction responses can be reversed and a previous, higher-level of performance can be restored.

Further, while above-described example embodiments of the invention are primarily described with respect to one-to-one communication sessions between UEs 1 and 2, it will be appreciated that other embodiments of the invention can be directed to group communication sessions that can include three or more UEs.

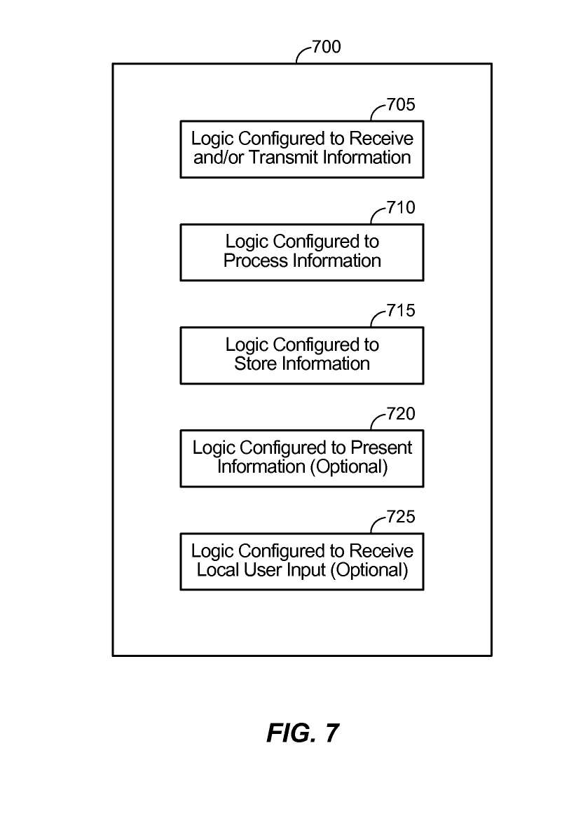

FIG. 7 illustrates a communication device 700 that includes logic configured to perform functionality in accordance with an embodiment of the invention. The communication device 700 can correspond to any of the above-noted communication devices, including but not limited to UEs 102, 108, 110, 112 or 200, Node Bs or base stations 124, the RNC or base station controller 122, a packet data network end-point (e.g., SGSN 160, GGSN 165, etc.), any of the servers 170 through 186, etc. Thus, communication device 700 can correspond to any electronic device that is configured to communicate with (or facilitate communication with) one or more other entities over a network.

Referring to FIG. 7, the communication device 700 includes logic configured to receive and/or transmit information 705. In an example, if the communication device 700 corresponds to a wireless communications device (e.g., UE 200, Node B 124, etc.), the logic configured to receive and/or transmit information 705 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 705 can correspond to a wired communications interface (e.g., a serial connection, a USB or Firewire connection, an Ethernet connection through which the Internet 175 can be accessed, etc.). Thus, if the communication device 700 corresponds to some type of network-based server (e.g., SGSN 160, GGSN 165, application server 170, etc.), the logic configured to receive and/or transmit information 705 can correspond to an Ethernet card, in an example, that connects the network-based server to other communication entities via an Ethernet protocol. In a further example, the logic configured to receive and/or transmit information 705 can include sensory or measurement hardware by which the communication device 700 can monitor its local environment (e.g., an accelerometer, a temperature sensor, a light sensor, an antenna for monitoring local RF signals, etc.). The logic configured to receive and/or transmit information 705 can also include software that, when executed, permits the associated hardware of the logic configured to receive and/or transmit information 705 to perform its reception and/or transmission function(s). However, the logic configured to receive and/or transmit information 705 does not correspond to software alone, and the logic configured to receive and/or transmit information 705 relies at least in part upon hardware to achieve its functionality.

Referring to FIG. 7, the communication device 700 further includes logic configured to process information 710. In an example, the logic configured to process information 710 can include at least a processor. Example implementations of the type of processing that can be performed by the logic configured to process information 710 includes but is not limited to performing determinations, establishing connections, making selections between different information options, performing evaluations related to data, interacting with sensors coupled to the communication device 700 to perform measurement operations, converting information from one format to another (e.g., between different protocols such as .wmv to .avi, etc.), and so on. For example, the processor included in the logic configured to process information 710 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 710 can also include software that, when executed, permits the associated hardware of the logic configured to process information 710 to perform its processing function(s). However, the logic configured to process information 710 does not correspond to software alone, and the logic configured to process information 710 relies at least in part upon hardware to achieve its functionality.

Referring to FIG. 7, the communication device 700 further includes logic configured to store information 715. In an example, the logic configured to store information 715 can include at least a non-transitory memory and associated hardware (e.g., a memory controller, etc.). For example, the non-transitory memory included in the logic configured to store information 715 can correspond to RAM memory, flash memory, ROM memory, EPROM memory, EEPROM memory, registers, hard disk, a removable disk, a CD-ROM, or any other form of storage medium known in the art. The logic configured to store information 715 can also include software that, when executed, permits the associated hardware of the logic configured to store information 715 to perform its storage function(s). However, the logic configured to store information 715 does not correspond to software alone, and the logic configured to store information 715 relies at least in part upon hardware to achieve its functionality.

Referring to FIG. 7, the communication device 700 further optionally includes logic configured to present information 720. In an example, the logic configured to present information 720 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 700. For example, if the communication device 700 corresponds to UE 200 as shown in FIG. 3A, the logic configured to present information 720 can include the display 224. In a further example, the logic configured to present information 720 can be omitted for certain communication devices, such as network communication devices that do not have a local user (e.g., network switches or routers, remote servers, etc.). The logic configured to present information 720 can also include software that, when executed, permits the associated hardware of the logic configured to present information 720 to perform its presentation function(s). However, the logic configured to present information 720 does not correspond to software alone, and the logic configured to present information 720 relies at least in part upon hardware to achieve its functionality.

Referring to FIG. 7, the communication device 700 further optionally includes logic configured to receive local user input 725. In an example, the logic configured to receive local user input 725 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 700. For example, if the communication device 700 corresponds to UE 200 as shown in FIG. 3A, the logic configured to receive local user input 725 can include the display 224 (if implemented a touch-screen), keypad 226, etc. In a further example, the logic configured to receive local user input 725 can be omitted for certain communication devices, such as network communication devices that do not have a local user (e.g., network switches or routers, remote servers, etc.). The logic configured to receive local user input 725 can also include software that, when executed, permits the associated hardware of the logic configured to receive local user input 725 to perform its input reception function(s). However, the logic configured to receive local user input 725 does not correspond to software alone, and the logic configured to receive local user input 725 relies at least in part upon hardware to achieve its functionality.

Referring to FIG. 7, while the configured logics of 705 through 725 are shown as separate or distinct blocks in FIG. 7, it will be appreciated that the hardware and/or software by which the respective configured logic performs its functionality can overlap in part. For example, any software used to facilitate the functionality of the configured logics of 705 through 725 can be stored in the non-transitory memory associated with the logic configured to store information 715, such that the configured logics of 705 through 725 each performs their functionality (i.e., in this case, software execution) based in part upon the operation of software stored by the logic configured to store information 715. Likewise, hardware that is directly associated with one of the configured logics can be borrowed or used by other configured logics from time to time. For example, the processor of the logic configured to process information 710 can format data into an appropriate format before being transmitted by the logic configured to receive and/or transmit information 705, such that the logic configured to receive and/or transmit information 705 performs its functionality (i.e., in this case, transmission of data) based in part upon the operation of hardware (i.e., the processor) associated with the logic configured to process information 710. Further, the configured logics or “logic configured to” of 705 through 725 are not limited to specific logic gates or elements, but generally refer to the ability to perform the functionality described herein (either via hardware or a combination of hardware and software). Thus, the configured logics or “logic configured to” of 705 through 725 are not necessarily implemented as logic gates or logic elements despite sharing the word “logic”. Other interactions or cooperation between the configured logics 705 through 725 will become clear to one of ordinary skill in the art from a review of the embodiments described above.

While references in the above-described embodiments of the invention have generally used the terms ‘call’ and ‘session’ interchangeably, it will be appreciated that any call and/or session is intended to be interpreted as inclusive of actual calls between different parties, or alternatively to data transport sessions that technically may not be considered as ‘calls’. Also, while above-embodiments have generally described with respect to PTT sessions, other embodiments can be directed to any type of communication session, such as a push-to-transfer (PTX) session, an emergency VoIP call, etc.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method, comprising:
receiving, during a communication session, media to be transmitted in association with the communication session between first and second user equipments (UEs);
detecting a session disruption during the communication session;
recording, in response to the detection of the session disruption, the received media;
detecting that the session disruption is no longer present; and
transmitting, responsive to the detection that the session disruption is no longer present, the recorded media.

2. The method of claim 1, wherein the received media includes audio data and/or video data and the communication session corresponds to a voice call and/or a video call.

3. The method of claim 1, wherein the receiving step, the detecting steps, the recording step and the transmitting step are performed by the first UE.

4. The method of claim 3, wherein the received media is input to the first UE by a user of the first UE.

5. The method of claim 4, wherein the received media is input to the first UE by the user speaking into an audio input device of the first UE.

6. The method of claim 4, wherein the transmitting step transmits the recorded media to an application server arbitrating the communication session for transmission to the second UE within the communication session.

7. The method of claim 4, wherein the transmitting step transmits the recorded media to an application server arbitrating the communication session for archival so that the recorded media can be accessed at a later point in time by the second UE.

8. The method of claim 7, wherein the archived media is accessible to the second UE during and/or after the communication session.

9. The method of claim 1, wherein the receiving step, the detecting steps, the recording step and the transmitting step are performed by an application server arbitrating the communication session between the first and second UEs.

10. The method of claim 9, wherein the transmitting step transmits the recorded media from the application server to the second UE.

11. The method of claim 9, wherein the recording of the received media corresponds to archival of the received media by the application server, further comprising:
receiving a request for the archived media from the second UE,
wherein the transmitting step transmits the archived media to the second UE in response to the request.

12. The method of claim 11, wherein the request is received during and/or after the communication session.

13. The method of claim 1, wherein the session disruption is caused by performance degradation and/or a disconnection (i) on a first communication path between the first UE and an application server arbitrating the communication session, and/or (ii) on a second communication path between the second UE and the application server.

14. The method of claim 1, wherein the communication session corresponds to a server-arbitrated communication session or a peer-to-peer (P2P) communication session.

15. The method of claim 1, wherein the communication session corresponds to a one-to-one communication session between the first and second UEs or a group communication session that includes the first and second UEs and at least one additional UE.

16. The method of claim 1, wherein the session disruption is caused by a signal fade condition at the first UE and/or the second UE.

17. The method of claim 1, wherein the session disruption is caused by backhaul congestion on a first communication path between the first UE and an application server arbitrating the communication, and/or backhaul congestion on a second communication path between the second UE and the application server.

18. The method of claim 1,
detecting a first session disruption associated with a first performance threshold;
reducing a quality of the communication session between the first and second UEs in response to the first session disruption;
detecting a second session disruption associated with a second performance threshold; and
further reducing the quality of the communication session between the first and second UEs in response to the second session disruption.

19. The method of claim 18, wherein the second session disruption corresponds to the detected session disruption that triggers the recording step.

20. The method of claim 18, wherein the detected session disruption that triggers the recording step corresponds to another session disruption beyond the second session disruption that is associated with another performance threshold.

21. The method of claim 18, wherein the reducing step that occurs in response to the first session disruption includes (i) transitioning the communication session from full-duplex to half-duplex, and/or (ii) transitioning the communication session from a video and audio session to an audio-only session.

22. A communication entity, comprising:
means for receiving, during a communication session, media to be transmitted in association with the communication session between first and second user equipments (UEs);
means for detecting a session disruption during the communication session;
means for recording, in response to the detection of the session disruption, the received media;
means for detecting that the session disruption is no longer present; and
means for transmitting, responsive to the detection that the session disruption is no longer present, the recorded media.

23. The communication entity of claim 22, wherein the communication entity corresponds to the first UE.

24. The communication entity of claim 22, wherein the communication entity corresponds to an application server arbitrating the communication session between the first and second UEs.

25. A communication entity, comprising:
logic configured to receive, during a communication session, media to be transmitted in association with the communication session between first and second user equipments (UEs);
logic configured to detect a session disruption during the communication session;
logic configured to record, in response to the detection of the session disruption, the received media;
logic configured to detect that the session disruption is no longer present; and
logic configured to transmit, responsive to the detection that the session disruption is no longer present, the recorded media.

26. The communication entity of claim 25, wherein the communication entity corresponds to the first UE.

27. The communication entity of claim 25, wherein the communication entity corresponds to an application server arbitrating the communication session between the first and second UEs.

28. A non-transitory computer-readable medium containing instructions stored thereon, which, when executed by a communication entity, cause the communication entity to perform operations, the instructions comprising:
program code to receive, during a communication session, media to be transmitted in association with the communication session between first and second user equipments (UEs);
program code to detect a session disruption during the communication session;
program code to record, in response to the detection of the session disruption, the received media;
program code to detect that the session disruption is no longer present; and
program code to transmit, responsive to the detection that the session disruption is no longer present, the recorded media.

29. The non-transitory computer-readable medium of claim 28, wherein the communication entity corresponds to the first UE.

30. The non-transitory computer-readable medium of claim 28, wherein the communication entity corresponds to an application server arbitrating the communication session between the first and second UEs.
